(19) United States
(12) Patent Application Publication
(10) Pub. No.: US 2023/0272306 A1
(43) Pub. Date: Aug. 31, 2023

(54) CLEANING COMPOSITIONS

(71) Applicant: RHODIA BRASIL S.A., Sao Paulo City (BR)

(72) Inventors: Livia Pereira, Campinas (CA); Sergio Martins, Campinas (BR); James Woods, Wilmington, DE (US); Derek Pakenha, Hamilton, NJ (US); Kamel Ramdani, Princeton, NJ (US); Diego Hernandes, Campinas (BR)

(73) Assignee: RHODIA BRASIL S.A., Sao Paulo City (BR)

(21) Appl. No.: 18/044,871

(22) PCT Filed: Sep. 9, 2021
(86) PCT No.: PCT/IB2021/058190

§ 371 Date: Mar. 10, 2023

Related U.S. Application Data
(60) Provisional application No. 63/076,979, filed on Sep. 11, 2020.

(51) Int. Cl. C11D 1/86; C11D 11/00; C11D 3/30; C11D 3/20; C11D 3/43

(52) U.S. Cl. CPC C11D 1/86; C11D 11/0017; C11D 11/0035; C11D 11/0052; C11D 11/0041; C11D 3/30; C11D 3/2086; C11D 3/43; C11D 1/72

(57) ABSTRACT

The present invention relates to the use of propoxylated methyl isobutyl carbinol or propoxylated di-isobutyl carbinol in cleaning compositions. In particular, the use of said carbinols provides improvement in cleaning performance for cleaning hard and soft surfaces.

This application claims priority filed on 11 Sep. 2020 in UNITED STATES with No. 63/076,979, the whole content of this application being incorporated herein by reference for all purposes.

### FIELD OF THE INVENTION

The present invention relates to the use of propoxylated methyl isobutyl carbinol or propoxylated di-isobutyl carbinol in cleaning compositions, in particular for cleaning hard and soft surfaces. The cleaning compositions comprise one of said carbinols and at least one of the following components: a surfactant, an alkalizing agent or acidifying agent, and water. Also, the present invention focuses on the use of the cleaning compositions, in particular for cleaning hard and soft surfaces.

### BACKGROUND OF THE INVENTION

A large variety of cleaning compositions intended for cleaning hard surfaces, such as the surfaces usually encountered in kitchens and bathrooms, is known in the field. Additionally, compositions for cleaning soft surface such as laundry detergence are also known.

These compositions usually contain surfactants, solvents, sequestrants, alkaline agents, acidifying agents, solubilizers, preserving agents, bactericides, fragrances, dyes and water.

Laundry detergent compositions also generally contain: builders, anti-redeposition agents, enzymes, active oxygen bleachers, optical brighteners, foam regulators and processing aids.

The solvent contained in these compositions is important in the final application of this type of product because it impacts directly on cleaning performance, ease of use, toxicity and evaporation of the product after applying it.

While a number of solvents for cleaning compositions are available and in commercial use, there remains a need in the art for new solvents that offer a favorable combination of water solubility, solubilization activity, easily obtaining process, toxicity and cost.

It would be advantageous if the cleaning compositions meet one or more customer needs, such as good solubilization activity, low toxicity, low cost and excellent cleaning performance. The inventors have now discovered that the use of propoxylated methyl isobutyl carbinol or propoxylated di-isobutyl carbinol cleaning compositions allows to increase significantly the cleaning performances of said cleaning compositions. Indeed, surprisingly, it has been found that the use of propoxylated methyl isobutyl carbinol or propoxylated di-isobutyl carbinol, present excellent solvent properties and are capable to increase the cleaning performance in cleaning compositions, as compared to standard cleaning compositions.

Typically, poly(alkylene oxides) compounds, as propoxylated methyl isobutyl carbinol or propoxylated di-isobutyl carbinol, can be obtained by processes known in the literature using gas—liquid reactors by feeding gaseous propylene oxide into the reactor containing a solution of said carbinol and an alkaline catalyst (KOH or NaOH) previously dissolved in an starter molecule (E. Santacesaria, “Polyethoxylation and polypropoxylation reactions: Kinetics, mass transfer and industrial reactor design”, Chinese Journal of Chemical Engineering 26 (2018), pp. 1235-1251).

By “increase the cleaning performances”, it is understood that the composition according to the invention is able to improve solubility of organic or inorganic substances like soil, dirt, oil, grease, polymer, wax, polish, ink, adhesive, mastic, photoresist, sealant, asphalt, sap, paint, varnish, or combinations thereof, on a substrate being a hard surface, such as tiles, metals, concrete, plastic and others, or a soft surface like leather or fabrics made of synthetic or natural fibers.

By “increase” or “improve”, it is meant an increase of performance in a range from 6% to 121% of: the cleaning composition that contain propoxylated methyl isobutyl carbinol or propoxylated di-isobutyl carbinol, compared to a standard cleaning composition that does not contain propoxylated methyl isobutyl carbinol or propoxylated di-isobutyl carbinol or; the cleaning composition that contain propoxylated methyl isobutyl carbinol with different degrees of propoxylation compared to the composition that contains propoxylated methyl isobutyl carbinol with two degrees of propoxylation according to the evaluation method of the experimental part.

Should the disclosure of any patents, patent applications, and publications which are incorporated herein by reference conflict with the description of the present application to the extent that it may render a term unclear, the present description shall take precedence.

### SUMMARY OF THE INVENTION

The present invention relates to the use of propoxylated methyl isobutyl carbinol or propoxylated di-isobutyl carbinol in cleaning compositions for cleaning hard and/or soft surfaces.

The present invention is also directed to cleaning compositions comprising at least one of the following components:
a. propoxylated methyl isobutyl carbinol or propoxylated di-isobutyl carbinol
b. at least one surfactant,
c. at least one alkalizing agent or acidifying agent,
d. water.

### DETAILED DESCRIPTION OF THE INVENTION

The present invention relates to the use of propoxylated methyl isobutyl carbinol (MIBC PO) or propoxylated di-isobutyl carbinol (DIBC PO) in cleaning compositions particularly for cleaning hard and/or soft surfaces.

Indeed, it has been discovered that the propoxylated methyl isobutyl carbinol (MIBC PO) or propoxylated di-isobutyl carbinol (DIBC PO) are solvents with excellent cleaning properties, which allow its use in compositions for this application.

By “propoxylated”, it is understood as repeated units (n) derived from propylene oxide added into a carbinol molecule such as methyl isobutyl carbinol to prepare propoxylated methyl isobutyl carbinol (MIBC PO) according to the Formula I

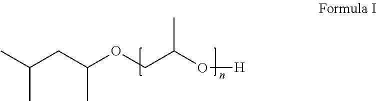

In a specific embodiment, the use of propoxylated methyl isobutyl carbinol (MIBC PO) or propoxylated di-isobutyl carbinol (DIBC PO) in cleaning composition is for cleaning hard surfaces such as in dish washing, glass cleaning, oven cleaning, multipurpose cleaning, bathroom cleaning, kitchen cleaning, perfumed cleaning, concrete cleaning and industrial removing, and also the use for soft surfaces cleaning such as laundry, leather or fabrics made of natural or synthetic fibres. Fabrics include woven or non-woven fabrics, for example carpet or textile. Synthetic fibers include polyester, polyamide, and others; natural fibres include cotton, silk, wool and others.

Non-limiting examples of surfaces that may be treated by using propoxylated methyl isobutyl carbinol (MIBC PO) or propoxylated di-isobutyl carbinol (DIBC PO) in cleaning compositions of the present invention are surfaces of refractory materials such as glazed and unglazed tiles, bricks, porcelain, ceramic and stone, marble, granite, stones and other surfaces; glass, metals, plastics, for example polyester, vinyl, glass fibre, Formica® surface, Corian® surface and other known hard surfaces used in cupboards and work surfaces and also wall and floor surfaces.

The use of propoxylated methyl isobutyl carbinol (MIBC PO) or propoxylated di-isobutyl carbinol (DIBC PO) in cleaning compositions of the present invention also find a use in the cleaning of metallic surfaces outside and inside kitchen and bathroom appliances, for example the metal surfaces of kitchen appliances, including, without being limited thereto, polished, chromium-plated, burnished surfaces or mat or brushed-metal surfaces as found on kitchen work surfaces, electrical appliance cases, the surfaces of appliances including external appliance surfaces such as doors, and also internal surfaces such as the internal spaces of dishwashers, ovens and cooking hobs.

The use of propoxylated methyl isobutyl carbinol (MIBC PO) or propoxylated di-isobutyl carbinol (DIBC PO) in compositions of the present invention afford the cleaning and reduction of stains, tarnishing or other discolorations of metal, such as those caused by the accumulation of soiling and grease or the oxidation of treated metal surfaces. Non-limiting examples of metals that may be mentioned include aluminium, copper, steel, stainless steel, brass and metal alloys that may comprise one or more of the above mentioned metals, and also non-metallic substrates with a metallic or metallized surface.

The use of propoxylated methyl isobutyl carbinol (MIBC PO) or propoxylated di-isobutyl carbinol (DIBC PO) in compositions of the present invention, when used in laundry detergency, afford removing stains and avoiding soils and dirt re-deposition without damaging the textile. The fibres of textiles used can include one or more of the materials listed: polyester, aramid, cotton, acrylic, wool, nylon, silk, Lycra® material, polyurethane.

Unexpectedly, the inventors have found that propoxylated methyl isobutyl carbinol (MIBC PO) or propoxylated di-isobutyl carbinol (DIBC PO), particularly in a mixture containing from 1 to 8 propoxylated compounds, when used in cleaning compositions, increases the cleaning performance of the cleaning composition compared to standard compositions containing other solvents such as propylene glycol n-butyl ether (PnB), dipropylene glycol n-butyl ether (DPnB), ethylene glycol n-butyl ether (EB), diethylene glycol n-butyl ether (DEB), propylene glycol phenyl ether (PPh) and d-limonene.

The cleaning performance is measured according to the test described in ASTM D4488-95.

A method of cleaning, for example, removing a substance such as a coating, soils and/or stains from a substrate comprises contacting the substance with a composition comprising propoxylated methyl isobutyl carbinol (MIBC PO) or propoxylated di-isobutyl carbinol (DIBC PO), said method comprising at least one of the foregoing under conditions that effect the removal, for example for a time effective to dissolve and/or lift the substance; and separating the dissolved and/or lifted material from the substrate. As used herein, “dissolved” includes partial dissolution of a material, often referred to as softening, such that the material can be further removed from the substrate by rinsing or mechanical action. Of course, the cleaning composition can also be at least partially removed by separating the material.

The use of the cleaning compositions can be to remove a wide variety of substances, generally those soluble or softenable by organic solvents. Examples include materials such as soils, stains, grease, inks for all types of substrates, including paper, wood, plastic, metal, textiles, ceramics, stone, skin, and for indoor or for outdoor use; adhesives and sealants, for example silicone, polyurethane, epoxy, polyvinyl acetate (including copolymers with ethylene), phenolic, amino resin, cyano acrylate, polyester, polyamide, rubber (styrene-butadiene and natural) or acrylic adhesives and sealants; mastics; photoresists; waxes, for example floor wax or bees wax; asphalts; saps (which as used herein includes pitches, rosins, tars, and natural resins such as tree sap); residual materials left in forms or molds, for example polymers such as alkyds, polyacetals, polyacrylates, polyacrylics, polyamides, polycarbonates, polyesters, polyethers, polyethylenes, polyimides, polystyrenes, polyurethanes, polyvinyls, silicones, natural and synthetic rubbers, and the like, and polymer additives; greases, for example silicone and petroleum-based greases; oils, including machine oil; and paints, finishes, and other coatings, for example, alkyd enamels, acrylic enamels, polyesters, polyurethanes, epoxy resin coatings, latex paints, oil-based paints, shellacs, phenolic coatings, gum varnishes, silicone coatings, polyvinyls, polyvinyl cinnamates, polyamides, polyimides, polyalkyl acrylates, polyalkyl methacrylates, drying oils, polyvinyl acrylates, and cellulosic resins.

The substrates that are treated with the cleaning compositions are reasonably resistant to the cleaning compositions, including natural and synthetic fabrics, wood, cardboard, and coated paper, especially if treated with a wax or other protective material, glass, thermoset resins, thermoplastic resins, ceramic, stone, masonry substrates, cement, or metals (e.g., aluminum alloys, zinc alloys, stainless steel, or galvanized steel).

Although the methods of contacting the surface with the cleaning composition can be accomplished in a number of ways, for example, in aerosol form or other spraying means such as by standard spray nozzles; brush application; dipping; coating; application in gel form such as from a squeeze bottle or brush, and the like, but immersion and spraying can be specifically mentioned. If the surface to be cleaned is readily accessible, then spraying can be used. The spraying pressure will usually be from 1.3 bars to 8.0 bars absolute pressure. The mechanical force of the impinging cleaning composition facilitates removal of the substance. On the other hand, if the surface to be cleaned has recesses or other shapes that are not readily accessible, immersion can be used. Of course, both methods can be used in combination and/or varied in ways apparent to those skilled in the art. During or after contacting, mechanical action, such as scraping, peeling, rubbing, wiping, and the like can be employed to increase contact and/or aid in dissolution and/or lifting.

The contact time needed to produce an effective degree of dissolution and/or lifting of the substance from a substrate will depend on the nature and thickness of the substance, the composition of the cleaning composition, including the ingredient concentrations, the temperature of the composition, and other factors. With some substances and under some conditions, contact times of a few minutes (e.g., 2-3 minutes) to an hour can be sufficient. Operating temperature when using the cleaning compositions can be from 0 to 180 degrees centigrade or higher, specifically 15 to 90 degrees centigrade, or 21 to 55 degrees centigrade. The treatment is most conveniently carried out at room temperature, but lift time can be shortened as desired by heating the cleaning compositions and/or substrate. Heating can be achieved by local application of heat such as with a heat gun, or more general application of heat, such as with an electric heater, infrared heater, and the like. It is to be understood however, that those skilled in the art can determine optimal conditions for particular removal applications by minimal experimentation. Higher temperatures generally increase the rate at which the substance is removed from the surface.

In a particular embodiment, by the use of the cleaning compositions of the present invention, the improvement in the performance means an increase of the cleaning performance in a range from 6 to 121% compared to the standard compositions measured by the standard ASTM D4488-95.

The present invention is also based on cleaning compositions comprising at least one of the following components:
a. propoxylated methyl isobutyl carbinol or propoxylated di-isobutyl carbinol
b. at least one surfactant,
c. at least one alkalizing agent or acidifying agent,
d. water.

Particularly, methyl isobutyl carbinol or di-isobutyl carbinol can be propoxylated in different degrees during the process of preparation, generally between 1 and 30.

According to one preferential embodiment, propoxylated methyl isobutyl carbinol (MIBC PO) or propoxylated di-isobutyl carbinol (DIBC PO) comprises a mixture from 1 to 14 propoxylated compounds preferably from 1 to 8.

In another embodiment of the present invention, the composition comprises from 0.1 to 60% by weight of propoxylated methyl isobutyl carbinol (MIBC PO) or propoxylated di-isobutyl carbinol (DIBC PO) based on the total weight of the cleaning composition. The cleaning composition containing from 0.3 to 45% by weight of propoxylated methyl isobutyl carbinol (MIBC PO) or propoxylated di-isobutyl carbinol (DIBC PO) is preferred.

A surfactant or combination of surfactants are organic substances whose main characteristic is the fact that they have an amphiphilic behavior, that is, they can interact with both polar and non-polar substances. This property is explained by the fact that these molecules have a hydrophobic and a hydrophilic regions. The hydrophobic part of the molecule interacts with soil and fat, and the hydrophilic part with water, forming a spherical micelle, where the soil is concentrated inside and electrostatic forces keep the water on the outside, so when a substrate is rinsed with water, the micelle is swept away with soil.

The amphiphilic behavior of surfactants gives them the ability to interact with compounds of different polarities and can be used as conciliators of immiscible phases, since it has the ability to reduce surface tension. This characteristic allows the formation of emulsions, foams, suspensions, or microemulsions, and can also be used for the formation of liquid films, and for wetting and cleaning of surfaces.

A wide variety of surfactants may be used in the compositions of the present invention, such as non-ionic, anionic, cationic and zwitterionic surfactants, and mixtures thereof.

The appropriate non-ionic surfactants comprise alkylamine oxides, for example C8-20 alkyldimethylamine oxides, alkylphenol ethoxylates, linear and branched alcohol ethoxylates, carboxylic acid esters, alkanolamides, alkylpolyglycosides, copolymers of ethylene oxide/propylene oxide, etc. Among these surfactants, linear and secondary alcohol ethoxylates, octylphenol and nonylphenol ethoxylates, alkanolamides and alkylpolyglycosides are particularly preferred. Mixtures of two or more above surfactants can be used. All those surfactants are commercially available.

The zwitterionic/amphoteric surfactants that are useful comprise alkylaminopropionic acids, alkyliminopropionic acids, imidazoline carboxylates, alkylbetaines, sulfobetaines and sultaines. Mixtures of two or more above can be used. All those surfactants are commercially available.

The cationic surfactants that are useful comprise primary amine salts, diamine salts, quaternary ammonium salts and ethoxylated amines. Mixtures of two or more above can be used. All those surfactants are commercially available.

The anionic surfactants that are useful, which are preferably used only in combination with a nonionic surfactant, comprise carboxylic acid salts, alkylbenzene sulfonates, alkylbenzenesulfonic acid, secondary n-alkanesulfonates, α-olefin sulfonates, dialkyl oxydiphenylene sulfonates, sulfosuccinate esters, isethionates, linear alcohol sulfates such as alkyl sulfates, for instance sodium lauryl sulfate, linear ethoxyalcohol sulfates and water-soluble salts of alkylbenzene sulfonates. Mixtures of two or more of the above can be used. All those surfactants are commercially available.

The compositions typically comprise from 0.5 to 60% by weight of surfactants based on the total weight of the cleaning composition. The cleaning composition containing 0.8 to 45% by weight of surfactants is preferred.

An alkalizing agent or an acidifying agent is commonly present in cleaning compositions. Such agents can be used in compositions of the present invention and may be any chemical compound or group of compounds that are capable of varying the pH of the composition in acceptable ranges. The pH used in each composition is determined by the type of surfactant and the type of application of the cleaning composition.

Preferably, the alkalizing agent is selected from the group consisting of monoethanolamine (MEA), potassium hydroxide, sodium hydroxide, triethanolamine (TEA) and methylisopropylamine (MIPA).

The compositions generally comprise the alkalizing agent in an amount from 0.01 to 15% by weight based on the total weight of the cleaning composition. The cleaning composition containing 0.05 to 10% by weight of alkalizing agent is preferred.

Preferably, the acidifying agent is selected from the group consisting of citric acid, tartaric acid, sodium citrate and lactic acid.

Typically, the compositions of the present invention comprise the acidifying agent in an amount from 0.05 to 10% by weight based on the total weight of the cleaning composition.

A particularly preferred cleaning composition of the present invention comprises:
a. from 0.30 to 45% by weight of propoxylated methyl isobutyl carbinol or propoxylated di-isobutyl carbinol as a solvent,
b. from 0.80% to 45% by weight of at least one surfactant,
c. from 0.05 to 10% by weight of at least one alkalizing or acidifying agent,
d. at least 30% by weight of water based on the total weight of the cleaning composition.

The compositions of the present invention optionally comprise other ingredients such as, without this list being limiting, a plurality of abrasive particles, an organic amine, hydrotropes, antioxidant, biocide, colorant, corrosion inhibitor, defoamer, dye, enzyme, fragrance, light stabilizer, odor masking agent, plasticizer, preservative, rust inhibitor, surfactant, thickener, soil suspending agent, builder or chelating agent, bleach, bleach activator, bleach stabilizer, pH control agent, fabric softening ingredient, pH adjusters like buffers, fragrance solubilizers, viscosity modifiers, optical brighteners, opacifiers, antistain agents, and sequestrants.

Exemplary builders include N-diethyleneglycol-N,N-diacetic (DID A), acid polyphosphates (e.g., potassium pyrophosphate), nitrilotriacetates (e.g., Na₃NTA), sodium ethylenediaminetetraacetate (EDTA), sodium ethylenetriaminepentaacetate, sodium citrate, sodium carbonate, sodium metasilicate and zeolites, e.g., zeolites having a cation exchange capacity (measured as CaCO₃) of 200 mg or greater per gram of zeolite.

Examples of hydrotropes are the alkali metal salts of a benzene, cumene, toluene and xylene sulfonate, ideally the sodium salt. Mixtures of two or more hydrotropes may also be used.

Exemplary fragrances can be composed by components extracted from plants and flowers, synthetic recreations (synthetic duplications of natural fragrances) and/or synthetic innovations (variations of naturally-occurring material which have unique olfactory properties). Those components can be alcohols, terpenics molecules, hydrocarbons, esters, ethers and ketones with different carbon chain length. We can cite essential oils, aroma chemicals, perfumes, and the like, for example, ambergris, borneol and its esters, carvone, castoreum, civet, cinnamaldehyde, citrals, clove oil, galbanum, jasmine, limonene, linalool and its esters, pinenes (alphas, betas, etc.), rosemary oil, sandalwood, terpineols, terpinenes, and the like, benzaldehyde, benzoin, isoamyl acetate (banana); isobutyl propionate (rum); methyl anthranilate (grape); benzyl acetate (peach), dipentene, methyl butyrate (apple); ethyl butyrate (pineapple); octyl acetate (orange); n-propyl acetate (pear); ethyl phenyl acetate (honey), and the like.

Exemplary plasticizers include phthalate esters, for example dibutyl phthalate, diethylhexyl phthalate and diethyl phthalate; aliphatic diesters, for example dioctyl adipate; terephthalate esters, for example dioctyl terephthalate; citrate esters, for example acetyl triethyl citrate and acetyl tri-n-butyl citrate; ketal based plasticizers, such as those described in PCT Application WO 2010/151558, or a combination comprising at least one of the foregoing.

Thickeners can be present to adjust the rheological properties of the cleaning compositions. For example, the removal of partially dried paint removal from automotive paint spray booths is generally performed by spraying a cleaning composition such as coatings remover onto the spray booth. The coatings remover must be thin enough to spray easily but must rapidly build in viscosity under low shear conditions to effectively cling to vertical surfaces. A higher viscosity composition is generally desired if the coatings remover is to be painted on while a low viscosity composition containing no added thickener can be used where the coated substrate is to be soaked in a tank. Thickeners can also serve to increase the effectiveness of the coatings removers by decreasing the rate of evaporation of the volatile components after application to a coated substrate. Use of a thickener in the composition enables the composition to be applied onto vertical surfaces without any attendant dripping or run-off therefrom, and also inhibits dissipation of the composition into porous substrates such as brick or concrete.

Exemplary thickeners are natural or synthetic clays including bentonite, hectorite, smectite and other silicates such as available grades of BENTOLITE™, CLAYTONE™ and GELWHITE™ bentonites, PERMON™ smectites, CLOISITE™ magnesium aluminum silicates, LAPONITE™ silicates and GARAMITE™ silicates (all available from Southern Clay Products, Inc.) and available grades of OPTIGEL™ bentonites, hectorites, smectites and other clays (all from Sued-Chemie Group); stearates of organoclay compounds such as tetraalkyl ammonium bentonite; gums and other polysaccharides such as carrageenan gum (e.g., GENUVISCO™ X-906-02 (from CP Kelco), cassia gum, diutan gum (e.g., GEOVIS™ XT, KELCO-CRETE™ 80, KELCO-CRETE 200 and KOC617 (all from CP Kelco)), gellan gum (e.g., KELCOGEL™, KELCOGEL F and KELCOGEL LT 100 (all from CP Kelco), guar gum, Gum Arabic, Gum Tragacanth, locust bean gum, whelan gum and Xanthan gum (e.g., KELZAN™, KELZAN AR, KELZAN ASX, KELZAN ASX T, KELZAN CC, KELZAN HP, KELZAN RD, KELZAN S, KELZAN ST, KELZAN T, KELTROL™, KELTROL T and KELTROL TF (all from CP Kelco) and VANZAN™ and VANZAN D (both from R.T. Vanderbilt Co.); hydrocolloids such as NOVEGUM™ C865, NOVEGUM C866 and NOVEGUM G888 (all from Noveon, Inc.); alginates such as agar; cellulose ethers such as ethyl cellulose, hydroxyethyl cellulose, ethyl hydroxyethyl cellulose, methyl cellulose, hydroxypropyl cellulose, hydroxypropyl methyl cellulose, and other alkyl or hydroxyalkyl cellulose ethers, commercially available, e.g., as METHOCEL™ K15MDGSE, METHOCEL K4MDGSE, METHOCEL 311, METHOCEL F4M PRG and METHOCEL OS (all from Dow), XDS 8898.5 cellulose ether (from Dow), and KLUCEL™ H, KLUCEL M or KLUCEL G (all from Ashland, Inc.); acrylic acid homopolymers or copolymers, e.g., those which can be neutralized with a salt including associative or non-associative thickeners such as ACUSOL™ 801s, ACUSOL 810, ACUSOL 810A, ACUSOL 820, ACUSOL 823 and ACQSOL 830 acrylate polymers (all from Rohm and Haas Co.) or those which can be crosslinked (e.g., with a polyalkenyl polyether) including CARBOPOL™ 674, CARBOPOL 676, CARBOPOL ETD 2691, CARBOPOL ETD 2623, CARBOPOL EZ-3, CARBOPOL EZ-3A, CARBOPOL EZ-4 and CARBOPOL ULTREZ™ 21 (all from Noveon, Inc.); PEMULEN™ 1622 copolymer (from Noveon, Inc.); polyethylene oxides (e.g., high molecular weight polyethylene oxides) such as polyethylene glycols and methoxypolyethylene glycols; polyvinyl alcohols; polyvinyl pyrrolidone; starches; polyurethanes including RHEOLATE™ 266 (from Elementis Specialties, Inc.), and available grades of OPTIFLO™ associative thickeners (all available from Sud-Chemie Group); and methyl vinyl ether/maleic anhydride copolymers. Other possible thickeners include hydrophobe-modified ethoxy urethane (HEUR) thickeners, hydrophobe-modified alkali soluble emulsion (HASE) thickeners, hydrophobe-modified hydroxyethyl cellulose (HM-HEC) thickeners, and HEUR-ASE combination thickeners. A combination comprising at least one of the foregoing can be used.

Enzymes such as proteases and amylases are also frequently present in cleaning compositions, especially laundry detergent products and prewash products.

The cleaning compositions can be in the form of a solid, a gel, a liquid, an emulsion. A single composition can have more than one use, for example a single composition can be used for cleaning both hard surfaces and soft surfaces.

The cleaning compositions can alternatively be formulated in other forms useful for cleaning compositions, for example gels, wipes, aerosols, and the like. The cleaning compositions can be formulated in gel form by the addition of an effective amount of a gelling agent such as fumed silica, organic gums, polymers, copolymers, paraffin wax, bentonite clay, and cellulose ethers such as methyl cellulose and hydroxypropyl methyl cellulose commercially available as METHOCEL® cellulose ethers, from Dow Chemical. Wipes are generally a natural or synthetic fabric piece impregnated with the gel or liquid cleaning composition. When used as an aerosol, the cleaning compositions are formulated under pressure with a propellant as is known in the art.

Specific language is used in the description so as to facilitate the understanding of the principle of the invention. It should, however, be understood that no limitation of the scope of the invention is envisaged by the use of this specific language. Modifications, improvements and perfections may especially be envisaged by a person skilled in the technical field concerned, on the basis of his own general knowledge.

Illustrating the invention are the following examples that are not to be considered as limiting the invention to their details.

Experimental Part

The cleaning efficacy for surface care was evaluated using a method described in standard ASTM D4488-95 “Standard Guide for Testing Cleaning Performance of Products Intended for Use on Resilient Flooring and Washable Walls”.
MIBC PO—Propoxylated methyl isobutyl carbinol was obtained by reacting methyl isobutyl carbinol and propylene oxide according to processes described in literature. The propoxylated MIBC obtained is a mixture containing 1 to 8 propoxylated compounds.
MIBC 2PO; MIBC 2.5PO; MIBC 6PO and MIBC 8PO—Propoxylated methyl isobutyl carbinol compositions with major amounts of referred degrees of propoxylation.
DPnB—Dipropylene Glycol n-Butyl Ether is obtained by Dow under the trade name of Dowanol DPnB.
d-limonene-1-methyl-4-(prop-1-en-2-yll)ciclohex-1-ene) is obtained by Univar Solutions under the name of Limonene.
PPh—Propylene Glycol Phenyl Ether is obtained by Dow under the trade name of Dowanol PPh.
PnB—Propylene Glycol n-Butyl Ether is obtained by Dow under the trade name of Dowanol PnB.
DEB—Diethylene Glycol n-Butyl Ether is obtained by Oxiteno under the name of Dibutyl glycol.
EB—Ethylene Glycol n-Butyl Ether is obtained by Oxiteno under the name of Butyl glycol.

### Examples

Compositions

Different compositions were prepared according to the present invention for different cleaning purposes using as a solvent, the MI BC PO.

To perform a comparative performance test, standard cleaning compositions using standard solvents were used as Table I and Table II below.

TABLE I
Cleaner compositions in w/w % for general surface cleaners.

| | Cleaner compositions w/w % | | | | | | | | | |
|---|---|---|---|---|---|---|---|---|---|---|
| | | | Hard | | | | | | | |
| | Disinfectant | | Surface | | Degreaser | | Multipurpose | | Perfumed | |
| Examples | 1 | 1.1 | 2 | 2.1 | 3 | 3.1 | 4 | 4.1 | 5 | 5.1 |
| Lauryl Alcohol 9EO 90% | 3 | 3 | | | | | | | | |
| Lauryl Alcohol 7EO 90% | | | 2.25 | 2.25 | 3 | 3 | | | 1.4 | 1.4 |
| Quaternary ammonium 50% | 4 | 4 | | | | | | | | |
| Dodecylbenzene Sodium | | | 0.7 | 0.7 | 1.2 | 1.2 | 1.5 | 1.5 | | |
| sulfonate 96% | | | | | | | | | | |
| DPnB | | 1 | | | | | | | | |
| MIBC PO | 1 | | 0.6 | | 2 | | 0.7 | | 0.35 | |
| PPh | | | | 0.6 | | | | | | |
| Citric acid | 1 | 1 | | | | | | | | |
| DPnB | | | | | | | | 0.7 | | |
| EB | | | | | | | | | | 0.35 |
| DEB | | | | | | 2 | | | | |
| Hydrogen peroxide 30% | 5 | 5 | | | | | | | | |
| Fragrance | 1 | 1 | 0.8 | 0.8 | 0.2 | 0.2 | 0.2 | 0.2 | 0.7 | 0.7 |
| Monoethanolamine 99% | | | 0.5 | 0.5 | 1 | 1 | 0.4 | 0.4 | 0.1 | 0.1 |

| | |
|---|---|
| water (pH = 8) | Up to 100% |

The compositions described in Table I are directed for general surface cleaners, using same amounts of each ingredient, including solvents, MI BC PO or comparator standard solvent.

TABLE II
Cleaner compositions in w/w % for specific
environment/surface cleaners.

| | Cleaner compositions w/w % | | | | | | | |
|---|---|---|---|---|---|---|---|---|
| | Industrial | | | | | | | |
| | Degreaser | | Bathroom | | Kitchen | | Glass | |
| Examples | 6 | 6.1 | 7 | 7.1 | 8 | 8.1 | 9 | 9.1 |
| Lauryl Alcohol 7EO 90% | 13 | 13 | 0.4 | 0.4 | 2.15 | 2.15 | | |
| Dodecylbenzene Sodium | | | 0.7 | 0.7 | 0.75 | 0.75 | 1.3 | 1.3 |
| sulfonate 96% | | | | | | | | |
| DPnB | | | — | 1.5 | | | | |
| MIBC PO | 6 | | 1.5 | — | 0.7 | | 1 | |
| d-limonene | | 6 | | | | | | |
| PnB | | | | | | 0.7 | | |
| Citric acid | | | 0.3 | 0.3 | | | | |
| EB | | | | | | | | 1 |
| Ethanol | | | | | 0.05 | 0.05 | 5 | 5 |
| Fragrance | | | | | | | 0.1 | 0.1 |
| Monoethanolamine 99% | | | | | 0.8 | 0.8 | 0.1 | 0.1 |

| | |
|---|---|
| water (pH = 8) | Up to 100% |

The compositions described in Table II are specific for some environment or surface cleaners and the examples use same amounts of each ingredient, including solvents, MBIC PO or comparator standard solvent.

TABLE III
Cleaning compositions in w/w % for comparing cleaning
performance at different propoxylation degrees of MIBC PO.

| | Cleaner compositions w/w % | | | |
|---|---|---|---|---|
| | Form- | Form- | Form- | Form- |
| | ulation | ulation | ulation | ulation |
| | with MIBC | with MIBC | with MIBC | with MIBC |
| | 2PO | 2,5PO | 6PO | 8PO |
| Examples | 10 | 10.1 | 10.2 | 10.3 |
| tetradecyl dimethyl | 1.0 | 1.0 | 1.0 | 1.0 |
| amine oxide 30% | | | | |
| MIBC 2PO | 0.5 | — | — | — |
| MIBC 2,5PO | — | 0.5 | — | — |
| MIBC 6PO | — | — | 0.5 | — |
| MIBC 8PO | — | — | — | 0.5 |
| Monoethanolamine | 0.2 | 0.2 | 0.2 | 0.2 |

99%

| | |
|---|---|
| water (pH = 8) | Up to 100% |

The compositions described in Table III are specific for comparative testing of cleaning performance of environmental or surface solvents and the examples use the same amounts of each ingredient, including solvents, specific MIBC PO in each comparative formulation.

Cleaning Performance—Evaluation Method

The test for evaluating the cleaning performance and the materials for performing the test are described below.

The cleaning performance was evaluated using a method described in standard ASTM D4488-95 “Standard Guide for Testing Cleaning Performance of Products Intended for Use on Resilient Flooring and Washable Walls”.

The results of the tests of different compositions were compared with the standard compositions for each case. Therefore, the results of the cleaning performance for compositions vary according to the standard composition.

Below are the comparatively normalized performances, where the performance of the standard compositions is considered 100% and the comparative composition is evaluated against the standard.

The test results of different degrees of propoxylation of MIBC PO (MIBC 2.5PO, MIBC 6PO and MIBC 8PO) used in each composition were compared with the composition with MIBC PO with two degrees of propoxylation (MIBC 2PO). Therefore, cleaning performance results for each composition vary according to the composition of MIBC 2PO.

Below are the comparatively normalized performances, where the performance of the MIBC 2PO composition is considered 100% and the comparative composition is evaluated against the MIBC 2PO composition.

TABLE IV
Cleaning performance % for compositions for
general surface cleaners

| | Cleaning performance | | | | | | | | | |
|---|---|---|---|---|---|---|---|---|---|---|
| | Dis- | | Hard | | | | Multi- | | | |
| | infectant | | Surface | | Degreaser | | purpose | | Perfumed | |
| Examples | 1 | 1.1 | 2 | 2.1 | 3 | 3.1 | 4 | 4.1 | 5 | 5.1 |
| Performance | 106 | 100 | 133 | 100 | 156 | 100 | 168 | 100 | 122 | 100 |

All compositions containing the propoxylated methyl-isobutyl carbinol (MIBC PO) as a solvent had improved cleaning performance when compared with standard cleaning compositions for hard surface cleaning. The increase in the cleaning performance observed was at least 6%, till the limit of 68% when compared to the standard compositions.

TABLE V
Cleaning performance % for compositions for specific
environment/surface cleaners.

| | Cleaning performance | | | | | | | |
|---|---|---|---|---|---|---|---|---|
| | Industrial | | | | | | | |
| | Degreaser | | Bathroom | | Kitchen | | Glass | |
| Examples | 6 | 6.1 | 7 | 7.1 | 8 | 8.1 | 9 | 9.1 |
| Performance | 129 | 100 | 107 | 100 | 221 | 100 | 179 | 100 |

Compositions for cleaning specific environments or surfaces had an increase in the cleaning performance of at least 7%, till the limit of 121% for compositions containing propoxylated methyl-isobutyl carbinol (MIBC PO) as a solvent when compared to the standard compositions.

TABLE VI
Cleaning performance for different propoxylation degrees of
MIBC PO for general surface cleaners.

| | Cleaner compositions w/w % | | | |
|---|---|---|---|---|
| | Formulation | Formulation | Formulation | Formulation |
| | with | with | with | with |
| | MIBC 2PO | MIBC 2,5PO | MIBC 6PO | MIBC 8PO |
| Examples | 10 | 10.1 | 10.2 | 10.3 |
| Performance | 100 | 108 | 112 | 111 |

Compositions with greater degrees of propoxylation of the methyl-isobutyl carbinol (MIBC PO) had an increased cleaning performance compared to compositions with methyl-isobutyl carbinol (MIBC PO) with lower degrees of propoxylation. The increase in cleaning performance observed was at least 8%, up to the limit of 12% when compared to the composition with methyl isobutyl carbinol with two degrees of propoxylation.

Each application has its particularities in relation to the formula used, for example, the variation of the concentration of assets, type of surfactant used and interaction between the components. These particularities directly influence cleaning performance and, therefore, it is important to note that it is only possible to compare cleaning performance in the same application.

Therefore, surprisingly, it has been found that the use of the above claimed propoxylated methyl-isobutyl carbinol (MIBC PO) or a similar one, propoxylated di-isobutyl carbinol (DIBC PO), in cleaning compositions allows an improved cleaning performance compared to different standard cleaning compositions, for a large number of cleaning compositions.

1. A method, comprising cleaning hard and/or soft surfaces with a cleaning composition comprising propoxylated methyl isobutyl carbinol or propoxylated di-isobutyl carbinol.

2. The method according to claim 1 for cleaning hard surfaces selecting from the group consisting of dish washing, glass cleaning, oven cleaning, multipurpose cleaning, bathroom cleaning, kitchen cleaning, perfumed cleaning, concrete cleaning and industrial removing, or for cleaning soft surfaces such as laundry, leather or fabrics made of natural or synthetic fibres.

3. The method according to claim 1, wherein the method improves the cleaning performance measured by the standard ASTM D4488-95 compared to a comparative cleaning composition without propoxylated methyl isobutyl carbinol or propoxylated di-isobutyl carbinol.

4. The method according to claim 3, wherein the improvement in the cleaning performance is in a range from 6 to 121% compared to the standard cleaning compositions.

5. A cleaning composition comprising at least one of the following components:
a. propoxylated methyl isobutyl carbinol or propoxylated di-isobutyl carbinol
b. at least one surfactant,
c. at least one alkalizing agent or acidifying agent,
d. water.

6. The composition according to claim 5, wherein the propoxylated methyl isobutyl carbinol or propoxylated di-isobutyl carbinol comprises a mixture from 1 to 14 propoxylated compounds preferably from 1 to 8.

7. The composition according to claim 6, comprising from 0.1 to 60% by weight of propoxylated methyl isobutyl carbinol or propoxylated di-isobutyl carbinol based on the total weight of the cleaning composition.

8. The composition according to claim 5, comprising at least one surfactant which is selected from the group consisting of non-ionic, anionic, cationic and zwitterionic surfactants.

9. The composition according to claim 8, wherein the surfactant is present in an amount from 0.5 to 60%, by weight based on the total weight of the cleaning composition.

10. The composition according to claim 5, comprising at least one alkalizing agent which is selected from the group consisting of monoethanolamine (MEA), potassium hydroxide, sodium hydroxide, triethanolamine (TEA) and methyl isopropylamine (MIPA).

11. The composition according to claim 10, wherein the alkalizing agent is present in an amount of 0.01 to 15%, by weight based on the total weight of the cleaning composition.

12. The composition according to claim 5, comprising at least one acidifying agent which is selected from the group consisting of citric acid, tartaric acid, sodium citrate and lactic acid.

13. The composition according to claim 12, wherein the acidifying agent is present in an amount from 0.01 to 15%, by weight based on the total weight of the cleaning composition.

14. The cleaning composition according to claim 5, comprising:
a. from 0.30 to 45% by weight of propoxylated methyl isobutyl carbinol or propoxylated di-isobutyl carbinol as a solvent,
b. from 0.80 to 45% by weight of at least one surfactant,
c. from 0.05 to 10% by weight of at least one alkalizing or acidifying agent,
d. at least 30% by weight of water, based on the total weight of the cleaning composition.
